(19) United States
(12) Patent Application Publication
(10) Pub. No.: US 2025/0380836 A1
(43) Pub. Date: Dec. 18, 2025

(54) GRILL LIDS INCLUDING MODULAR REAR WALL PANELS

(71) Applicant: Weber-Stephen Products LLC, Palatine, IL (US)

(72) Inventors: Mark S. Latocha, Algonquin, IL (US); Timothy M. Bentz, Bartlett, IL (US); David A. Larson, Ingleside, IL (US); Karol Polaczek, JR., Hickory Hills, IL (US); Eric Bedard, St. Charles, IL (US); Brian C. Donnelly, Naperville, IL (US)

(21) Appl. No.: 19/027,594

(22) Filed: Jan. 17, 2025

Related U.S. Application Data
(60) Provisional application No. 63/659,737, filed on Jun. 13, 2024.

(51) Int. Cl. A47J 37/07

(52) U.S. Cl. CPC A47J 37/07

(57) ABSTRACT

Grill lids including modular rear wall panels are disclosed. An example grill includes a cookbox, a lid, and a rear wall panel. The lid includes an outlet located along a rear portion of the lid. The rear wall panel is removably couplable to the lid. The rear wall panel is configured to occupy at least a portion of the outlet when the rear wall panel is coupled to the lid.

### RELATED APPLICATIONS

This application claims priority to U.S. Provisional Patent Application No. 63/659,737, filed Jun. 13, 2024. The entirety of U.S. Provisional Patent Application No. 63/659,737 is hereby incorporated by reference herein.

### FIELD OF THE DISCLOSURE

This disclosure relates generally to grill lids and, more specifically, to grill lids including modular rear wall panels.

### BACKGROUND

Grills (e.g., gas grills, electric grills, charcoal grills, pellet grills, etc.) typically include a cookbox and a lid that collectively define a cooking chamber of the grill, with the lid being movable relative to the cookbox between a closed position and an open position. The cooking chamber becomes accessible to a user of the grill when the lid is moved from the closed position toward or into the open position. Conversely, the cooking chamber is generally inaccessible to the user of the grill when the lid is in the closed position. User access to the cooking chamber of the grill may periodically become necessary, for example, to add an item of food to the cooking chamber (e.g., at or toward the beginning of a cooking process), to remove an item of food from the cooking chamber (e.g., at or toward the end of a cooking process), and/or to flip, rotate, relocate, or otherwise move an item of food within the cooking chamber (e.g., during the middle of a cooking process).

Conventional grill lids often have a generally dome-shaped profile including a continuous (e.g., one piece) wall that forms at least a front portion, a top portion, and a rear portion (and often also right and left side portions) of the lid, with the front and rear portions (and often also the right and left side portions) extending downward from the top portion and defining a lower rim of the lid. Such conventional grill lids are constructed, fabricated, manufactured, and or otherwise formed such that at least the front, top, and rear portions (and often also the right and left side portions) of the lid are integrally formed and inseparable from one another.

In some known examples, conventional grill lids include one or more opening(s) formed in and extending through the rear portion of the lid, with such opening(s) being configured to vent heated air from within the cooking chamber of the grill to a location that is external to the cooking chamber. In other known examples, a gap is present between a lower edge of the rear portion of the lid and an upper edge of a rear wall of the cookbox of the grill, with the gap being configured to vent heated air from within the cooking chamber of the grill to a location that is external to the cooking chamber.

### BRIEF DESCRIPTION OF THE DRAWINGS

FIG. 1 is a first perspective view of an example rear wall panel constructed in accordance with the teachings of this disclosure, and configured for use with and/or installation on a lid of a grill.

FIG. 2 is a second perspective view of the rear wall panel of FIG. 1.

FIG. 3 is a first perspective view of an example lid constructed in accordance with the teachings of this disclosure.

FIG. 4 is a second perspective view of the lid of FIG. 3.

FIG. 5 is a rear view of the lid of FIGS. 3 and 4.

FIG. 6 is a top view of the lid of FIGS. 3-5.

FIG. 7 is a cross-sectional view of the lid of FIGS. 3-6, taken along section A-A of FIG. 6.

FIG. 8 is a first perspective view of the cross-sectional view of FIG. 7.

FIG. 9 is a second perspective view of the cross-sectional view of FIG. 7.

FIG. 10 is a perspective view of an example lid assembly including the rear wall panel of FIGS. 1 and 2 and the lid of FIGS. 3-9.

FIG. 11 is a rear view of the lid assembly of FIG. 10.

FIG. 12 is a cross-sectional view of the lid assembly of FIGS. 10 and 11, taken along section A-A of FIG. 6.

FIG. 13 is a first perspective view of the cross-sectional view of FIG. 12.

FIG. 14 is a second perspective view of the cross-sectional view of FIG. 12.

FIG. 15 is a first perspective view of an example cooking chamber assembly including an example cookbox and the lid assembly of FIGS. 10-14, with the lid of the lid assembly shown in an example closed position relative to the cookbox.

FIG. 16 is a second perspective view of the cooking chamber assembly of FIG. 15.

FIG. 17 is a rear view of the cooking chamber assembly of FIGS. 15 and 16.

FIG. 18 is a perspective view of the cooking chamber assembly of FIGS. 15-17, with the lid of the lid assembly shown in an example open position relative to the cookbox.

FIG. 19 is a first perspective view of an example grill including the cooking chamber assembly of FIGS. 15-18.

FIG. 20 is a second perspective view of the grill of FIG. 19.

FIG. 21 is a first perspective view of another example rear wall panel constructed in accordance with the teachings of this disclosure, and configured for use with and/or installation on a lid of a grill.

FIG. 22 is a second perspective view of the rear wall panel of FIG. 21.

FIG. 23 is a perspective view of an example lid assembly including the rear wall panel of FIGS. 21 and 22 and the lid of FIGS. 3-9.

Certain examples are shown in the above-identified figures and described in detail below. In describing these examples, like or identical reference numbers are used to identify the same or similar elements. The figures are not necessarily to scale and certain features and certain views of the figures may be shown exaggerated in scale or in schematic for clarity and/or conciseness.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### DETAILED DESCRIPTION

As discussed above, conventional grill lids typically include a continuous wall forming at least a front portion, a top portion, and a rear portion (and often also right and left side portions) of the lid, with said portions being integrally formed with one another such that the respective portions are inseparable from one another. Unlike such conventional grill lids, example grill lids disclosed herein include modular rear wall panels that are removably couplable to the lid. In some disclosed examples, a grill includes a cookbox, a lid, and a rear wall panel. The lid includes an outlet located along a rear portion of the lid. The rear wall panel is removably couplable to the lid. The rear wall panel is configured to occupy at least a portion of the outlet when the rear wall panel is coupled to the lid.

In some disclosed examples, the rear wall panel includes an upper edge, a lower edge, a right edge, a left edge, a front surface, and a rear surface. The lower edge is located opposite the upper edge. The right edge extends between the upper edge and the lower edge. The left edge is located opposite the right edge and extends between the upper edge and the lower edge. The front surface extends between the upper edge, the lower edge, the right edge, and the left edge. The rear surface is located opposite the front surface and extends between the upper edge, the lower edge, the right edge, and the left edge.

In some disclosed examples, when the rear wall panel is coupled to the lid, the lower edge of the rear wall panel forms a portion of a lower rim of a lid assembly that includes the lid and the rear wall panel. In some disclosed examples, the lower edge of the rear wall panel is linear. In some disclosed examples, the front surface of the rear wall panel is configured to face toward a front portion of the lid when the rear wall panel is coupled to the lid. In some disclosed examples, the front surface and the rear surface of the rear wall panel are free of any openings extending therethrough. In other disclosed examples, the rear wall panel includes one or more opening(s) extending through the front surface and the rear surface of the rear wall panel.

In some disclosed examples, the outlet is defined by an edge of the rear portion of the lid. In some disclosed examples, the lid and the rear wall panel are configured such that the upper edge, the right edge, and the left edge of the rear wall panel are positioned adjacent to the edge of the rear portion of the lid when the rear wall panel is coupled to the lid. In some disclosed examples, the edge of the rear portion of the lid includes a right segment, a left segment located opposite the right segment, and an upper segment extending between the right segment and the left segment, with the lid and the rear wall panel being configured such that the upper edge, the right edge, and the left edge of the rear wall panel are respectively positioned adjacent to corresponding ones of the upper segment, the right segment, and the left segment of the edge of the rear portion of the lid when the rear wall panel is coupled to the lid.

In some disclosed examples, the rear wall panel further includes a first mounting flange located along the right edge and a second mounting flange located along the left edge. In some disclosed examples, the second mounting flange is oriented parallel relative to the first mounting flange. In some disclosed examples, the first mounting flange and the second mounting flange are oriented perpendicularly relative to the front surface. In some disclosed examples, the first mounting flange includes a first opening configured to receive a first fastener, and the second mounting flange includes a second opening configured to receive a second fastener. In some disclosed examples, the rear wall panel is configured to be coupled to the lid via the first fastener and the second fastener. In some disclosed examples, the first fastener extends through the first opening of the first mounting flange and the second fastener extends through the second opening of the second mounting flange when the rear wall panel is coupled to the lid.

In some disclosed examples, the rear wall panel is configured to occupy a majority of the outlet when the rear wall panel is coupled to the lid. In some disclosed examples, the rear wall panel is configured to occupy a substantial entirety of the outlet when the rear wall panel is coupled to the lid.

In some disclosed examples, the lid is pivotally coupled to the cookbox. In some disclosed examples, the lid is movable relative to the cookbox between a closed position and an open position. In some disclosed examples, the cookbox, the lid, and the rear wall panel are configured such that a lower edge of the rear wall panel is spaced apart from an upper edge of a rear wall of the cookbox by a gap when the rear wall panel is coupled to the lid and the lid is in the closed position. In some disclosed examples, the gap is configured to vent heated air from within a cooking chamber of the grill to a location that is external relative to the cooking chamber, wherein the cooking chamber is defined at least in part by the cookbox, the lid, and the rear wall panel. In some disclosed examples, the gap has a minimum height of 1.0 millimeter. In some disclosed examples, the gap has a maximum height of 50.0 millimeters.

In some disclosed examples, the rear wall panel and/or one or more component(s) of the lid of the grill are placed into and/or remain in an uncoupled and/or unassembled state relative to one another during packaging and/or shipping of the grill. The ability to maintain the rear wall panel and/or the other component(s) of the lid in an uncoupled and/or unassembled state relative to one another during packaging and/or shipping advantageously enables the contents and/or components of the grill to be loaded into a shipping container (e.g., a box) having one or more dimension(s) that is/are reduced relative to the dimension(s) that would otherwise be necessary to contain the same contents and/or components of the packaged and/or shipped grill in instances when the rear wall panel and/or the other component(s) the lid are coupled to one another in an assembled state.

In some disclosed examples, different modular rear wall panels can interchangeably be removably coupled to the lid of the grill. The interchangeability of such modular rear wall panels advantageously facilitates a modular and/or customizable lid assembly system in which different ones of the modular rear wall panels having different lower edge shape features (e.g., a first rear wall panel having a linear lower edge, a second rear wall panel having a non-linear lower edge, etc.), different vent opening features (e.g., a first rear wall panel lacking any vent openings extending therethrough, a second rear wall panel having one or more vent opening(s) extending therethrough, etc.), and/or different height features (e.g., a first rear wall panel having a first height, a second rear wall panel having a second height differing from the first height, etc.) can selectively and/or interchangeably be coupled to the lid of the grill to provide unique, customized, and/or different versions of the lid assembly of the grill. Each such different version of the lid assembly of the grill advantageously includes and/or advantageously provides a unique, customized, and/or different venting profile, venting pattern, venting capacity, and/or venting capability associated therewith when such different version of the lid assembly is coupled to a cookbox to form a cooking chamber assembly of the grill.

The above-identified features as well as other advantageous features of example grill lids including modular rear wall panels are further described below in connection with the figures of the application.

As used herein, the term “configured” means sized, shaped, arranged, structured, oriented, positioned, and/or located. For example, in the context of a first part configured to fit within a second part, the first part is sized, shaped, arranged, structured, oriented, positioned, and/or located to fit within the second part.

As used herein in the context of a first object circumscribing a second object, the term “circumscribe” means that the first object is constructed around and/or defines an area around the second object. In interpreting the term “circumscribe” as used herein, it is to be understood that the first object circumscribing the second object can include gaps and/or can consist of multiple spaced-apart objects, such that a boundary formed by the first object around the second object is not necessarily a continuous boundary.

As used herein, unless otherwise stated, the terms “above” and “below” describe the relationship of two parts relative to Earth. For example, as used herein, a first part is “above” a second part if the second part is closer to Earth than the first part is. As another example, as used herein, a first part is “below” a second part if the first part is closer to Earth than the second part is. It is to be understood that a first part can be above or below a second part with one or more of: another part or parts therebetween; without another part therebetween; with the first and second parts contacting one another; or without the first and second parts contacting one another.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts at the point (or points) of contact between the two parts.

As used herein, the term “fastener” means any device(s), structure(s), and/or material(s) that is/are configured, individually or collectively, to couple, connect, attach, and/or fasten one or more component(s) to one or more other component(s). For example, a fastener can be implemented by any type(s) and/or any number(s) of bolts, nuts, screws, posts, anchors, rivets, pins, clips, ties, welds, adhesives, etc.

As used herein in the context of describing the relationship between two structures, the term “in fluid communication” means that the two structures are individually and/or collectively configured to allow a fluid (e.g., a gas or a liquid) to pass (e.g., to flow) from the first of the two structures to the second of the two structures, or vice-versa. For example, a second duct may be described as being in fluid communication with a first duct when a fluid (e.g., a gas or a liquid) is able to pass (e.g., to flow) from the first duct into the second duct, or from the second duct into the first duct.

As used herein, the terms “substantially” and/or “approximately” modify their subjects and/or values to recognize the potential presence of variations that occur in real world applications. For example, “substantially” and/or “approximately” may modify dimensions that may not be exact due to manufacturing tolerances and/or other real-world imperfections as will be understood by persons of ordinary skill in the art. For example, “substantially” and/or “approximately” may indicate such dimensions may be within a tolerance range of +/−10% unless otherwise specified in the description provided herein.

As used herein, the terms “including” and “comprising” (and all forms and tenses thereof) are open-ended terms. Thus, whenever the written description or a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein.

Furthermore, although individually listed, a plurality of means, elements, or method actions may be implemented by, for example, the same entity or object. Additionally, although individual features may be included in different examples or claims, these may possibly be combined, and the inclusion in different examples or claims does not imply that a combination of features is not feasible and/or advantageous.

The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C.

As used herein, when the phrase “at least” is used as the transition term in, for example, a preamble of a claim, it is open-ended in the same manner as the term “comprising” and “including” are open-ended. As used herein in the context of describing structures, components, items, objects, and/or things, the phrase “at least one of A and B” is intended to refer to implementations including any of (1) at least one A, (2) at least one B, or (3) at least one A and at least one B. Similarly, as used herein in the context of describing structures, components, items, objects, and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, and/or steps, the phrase “at least one of A or B” is intended to refer to implementations including any of (1) at least one A, (2) at least one B, or (3) at least one A and at least one B.

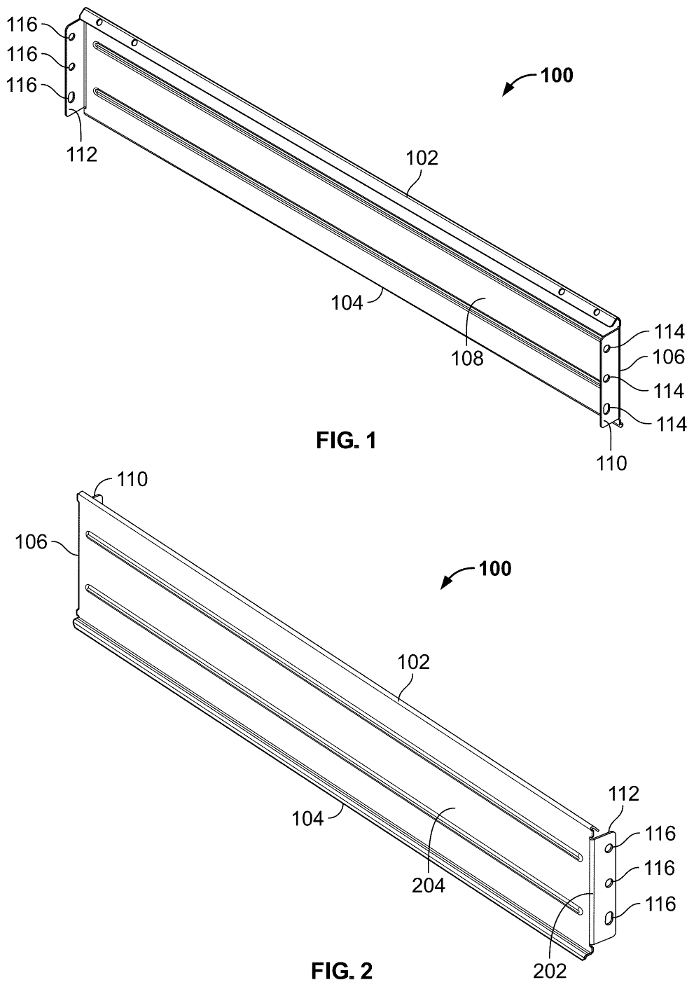

FIG. 1 is a first perspective view of an example rear wall panel 100 constructed in accordance with the teachings of this disclosure, and configured for use with and/or installation on a lid of a grill. FIG. 2 is a second perspective view of the rear wall panel 100 of FIG. 1. The rear wall panel 100 of FIGS. 1 and 2 is removably couplable to a lid of a grill. When the rear wall panel 100 is coupled to the lid, the rear wall panel 100 occupies (e.g., fills, extends across, and/or covers) at least a portion of an outlet formed along a rear portion of the lid, as further described herein. In some examples, the rear wall panel 100 occupies a majority (e.g., fifty percent or more) of the outlet when the rear wall panel 100 is coupled to the lid. In some examples, the rear wall panel 100 occupies a substantial entirety (e.g., ninety percent or more) of the outlet when the rear wall panel 100 is coupled to the lid.

In the illustrated example of FIGS. 1 and 2, the rear wall panel 100 includes an example upper edge 102, an example lower edge 104, an example right edge 106, an example left edge 202, an example front surface 108, and an example rear surface 204. The lower edge 104 of the rear wall panel 100 is located opposite the upper edge 102 of the rear wall panel 100. The right edge 106 of the rear wall panel 100 extends between the upper edge 102 and the lower edge 104 of the rear wall panel 100. The left edge 202 of the rear wall panel 100 is located opposite the right edge 106 of the rear wall panel 100, and extends between the upper edge 102 and the lower edge 104 of the rear wall panel 100. The front surface 108 of the rear wall panel 100 extends between the upper edge 102, the lower edge 104, the right edge 106, and the left edge 202 of the rear wall panel 100. The rear surface 204 of the rear wall panel 100 is located opposite the front surface 108 of the rear wall panel 100, and extends between the upper edge 102, the lower edge 104, the right edge 106, and the left edge 202 of the rear wall panel 100.

As shown in FIGS. 1 and 2, the upper edge 102, the lower edge 104, the right edge 106, and the left edge 202 of the rear wall panel 100 are linear (e.g., straight). In other examples, the upper edge 102, the lower edge 104, the right edge 106, and/or the left edge 202 of the rear wall panel 100 can instead be non-linear (e.g., curved, contoured, etc.). For example, the lower edge 104 of the rear wall panel 100 can instead be configured to include one or more curve(s), contour(s), notch(es), cutout(s), etc., the presence of which cause(s) the lower edge 104 to be non-linear. The lower edge 104 of the rear wall panel 100 of FIGS. 1 and 2 is configured to define and/or form a portion of a lower rim of a lid assembly (e.g., the lid assembly being formed by the rear wall panel 100 and the lid) when the rear wall panel 100 is coupled to the lid, as further described herein.

The front surface 108 of the rear wall panel 100 of FIGS. 1 and 2 is configured to face toward a front portion of the lid when the rear wall panel 100 is coupled to the lid, as further described herein. Conversely, the rear surface 204 of the rear wall panel 100 of FIGS. 1 and 2 is configured to face away from the front portion of the lid when the rear wall panel 100 is coupled to the lid. In the illustrated example of FIGS. 1 and 2, the front surface 108 and the rear surface 204 of the rear wall panel 100 are free of (e.g., do not include) any openings formed in and extending therethrough. In this regard, the rear wall panel 100 of FIGS. 1 and 2 does not include any vents, any through holes, and/or any other openings formed in and extending through the front surface 108 and/or the rear surface 204 of the rear wall panel 100. In other examples, the rear wall panel 100 can instead be configured to include one or more vent(s), one or more through hole(s), and/or one or more other opening(s) formed in and extending through the front surface 108 and the rear surface 204 of the rear wall panel 100.

As described above, the rear wall panel 100 of FIGS. 1 and 1 occupies (e.g., fills, extends across, and/or covers) at least a portion of an outlet formed along a rear portion of the lid when the rear wall panel 100 is coupled to the lid. In some examples, the outlet is defined by an edge of the rear portion of the lid. In some examples, the lid and the rear wall panel 100 are configured such that the upper edge 102, the right edge 106, and the left edge 202 of the rear wall panel 100 engage and/or are positioned adjacent to the edge of the rear portion of the lid when the rear wall panel 100 is coupled to the lid. In some examples, the edge of the rear portion of the lid includes a right segment, a left segment located opposite the right segment, and an upper segment extending between the right segment and the left segment. In some such examples, the lid and the rear wall panel 100 are configured such that the upper edge 102, the right edge 106, and the left edge 202 of the rear wall panel 100 respectively engage and/or are respectively positioned adjacent to corresponding ones of the upper segment, the right segment, and the left segment of the edge of the rear portion of the lid when the rear wall panel 100 is coupled to the lid.

The rear wall panel 100 of FIGS. 1 and 2 further includes an example first mounting flange 110 located along the right edge 106 of the rear wall panel 100, and an example second mounting flange 112 located along the left edge 202 of the rear wall panel 100. In the illustrated example of FIGS. 1 and 2, the second mounting flange 112 of the rear wall panel 100 is oriented parallel relative to the first mounting flange 110 of the rear wall panel 100. In other examples, the second mounting flange 112 of the rear wall panel 100 can instead be oriented at an angle relative to the first mounting flange 110 of the rear wall panel 100 such that the second mounting flange 112 is not oriented parallel relative to the first mounting flange 110. In the illustrated example of FIGS. 1 and 2, the first mounting flange 110 and the second mounting flange 112 of the rear wall panel 100 are oriented perpendicularly relative to the front surface 108 of the rear wall panel 100. In other examples, the first mounting flange 110 and/or the second mounting flange 112 of the rear wall panel 100 can instead be oriented at a non-perpendicular angle relative to the front surface 108 of the rear wall panel 100. In the illustrated example of FIGS. 1 and 2, the first mounting flange 110 and the second mounting flange 112 of the rear wall panel 100 extend in a forward direction from the front surface 108 of the rear wall panel 100. In other examples, the first mounting flange 110 and/or the second mounting flange 112 of the rear wall panel 100 can instead extend in a rearward direction from the rear surface 204 of the rear wall panel 100.

As shown in FIGS. 1 and 2, the first mounting flange 110 of the rear wall panel 100 includes one or more example first opening(s) 114 configured to receive a corresponding one or more first threaded fastener(s). The second mounting flange 112 of the rear wall panel 100 of FIGS. 1 and 2 similarly includes one or more example second opening(s) 116 configured to receive a corresponding one or more second threaded fastener(s). The rear wall panel 100 of FIGS. 1 and 2 is configured to be coupled to the lid via the first threaded fastener(s) and the second threaded fastener(s) associated with corresponding ones of the first opening(s) 114 of the first mounting flange 110 and the second opening(s) 116 of the second mounting flange 112. When the rear wall panel 100 of FIGS. 1 and 2 is coupled to the lid, the first threaded fastener(s) extend(s) through the first opening(s) 114 of the first mounting flange 110, and the second threaded fastener(s) extend(s) through the second opening(s) 116 of the second mounting flange 112. The rear wall panel 100 can be coupled and/or attached to the lid by tightening or otherwise securing the first threaded fasteners and the second threaded fasteners. Conversely, the rear wall panel 100 can be uncoupled and/or detached from the lid by loosening or otherwise removing the first threaded fasteners and the second threaded fasteners. In some examples, the rear wall panel 100 of FIGS. 1 and 2 and the lid collectively form a lid assembly when the rear wall panel 100 is coupled to the lid, as further described herein.

In the illustrated example of FIGS. 1 and 2, the rear wall panel 100 is configured to have a height (e.g., measured between the upper edge 102 and the lower edge 104 of the rear wall panel 100) of approximately 11.0 centimeters, and a lateral width (e.g., measured between the right edge 106 and the left edge 202 of the rear wall panel 100) of approximately 61.0 centimeters. In other examples, the height and/or the lateral width of the rear wall panel 100 can differ significantly relative to the above-described dimensions. In this regard, it is to be understood that the rear wall panel 100 will be configured such that the height and/or the lateral width chosen for the rear wall panel 100 will be dictated in part by a height and/or a lateral width chosen for the outlet of the lid that is to be occupied by the rear wall panel 100 when the rear wall panel 100 is coupled to the lid, as further described herein.

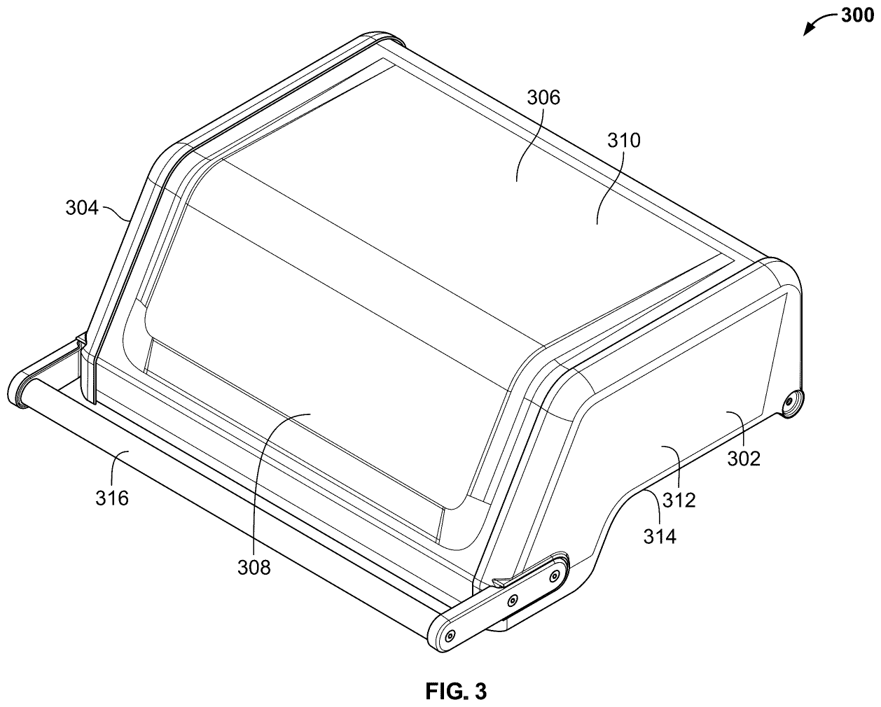

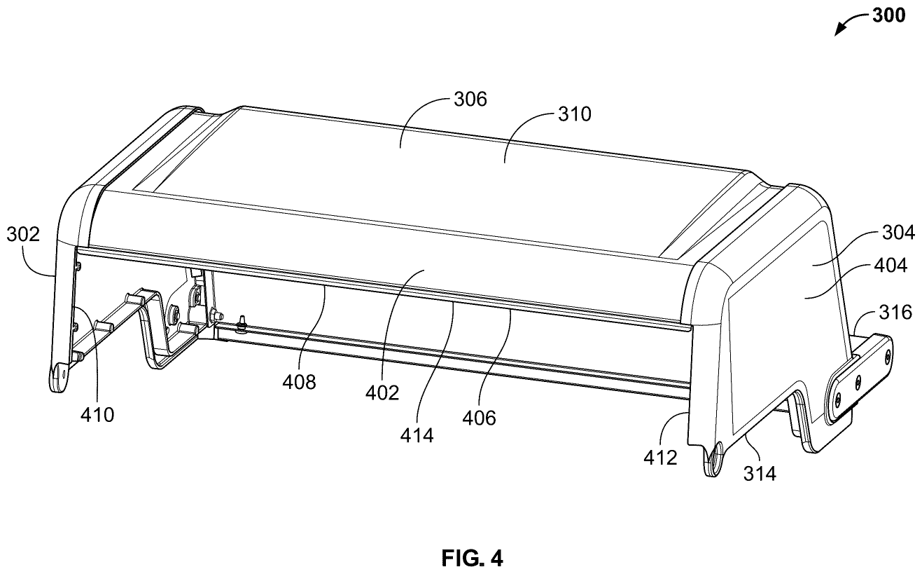

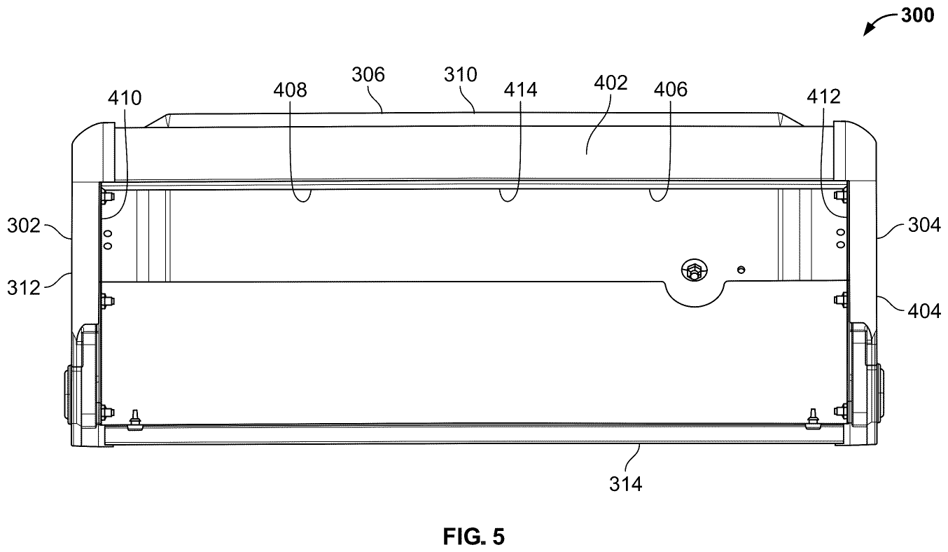

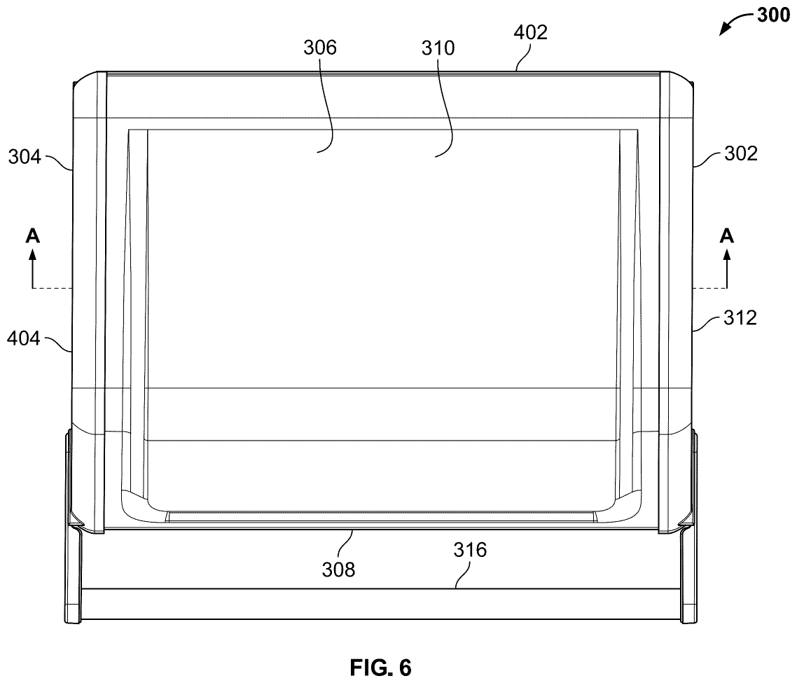

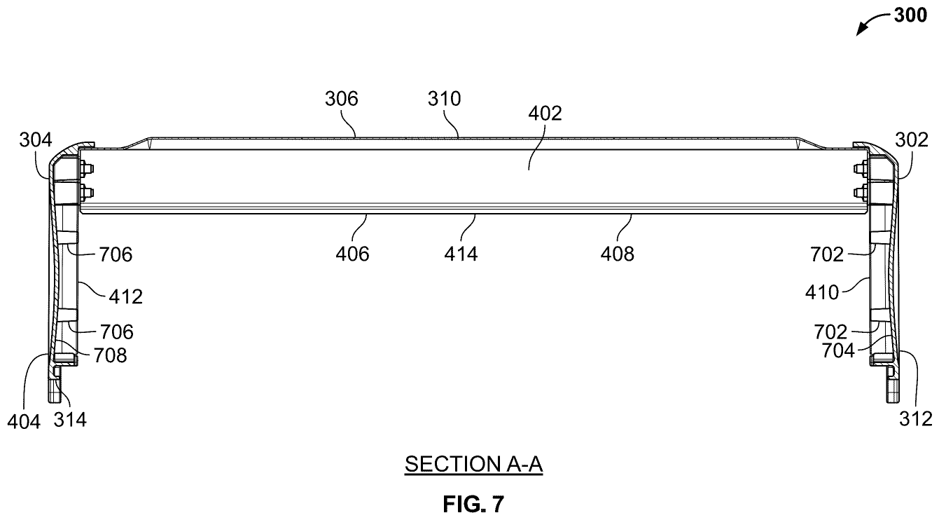

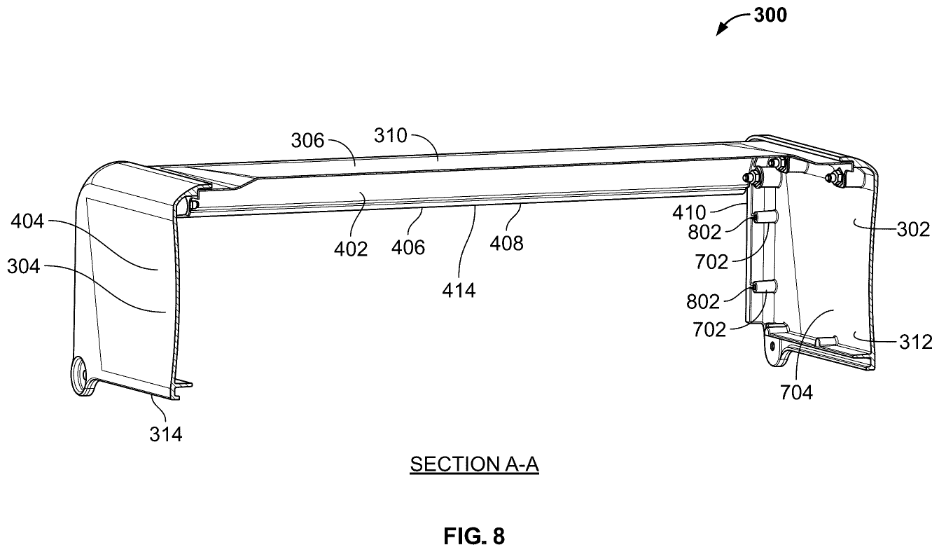

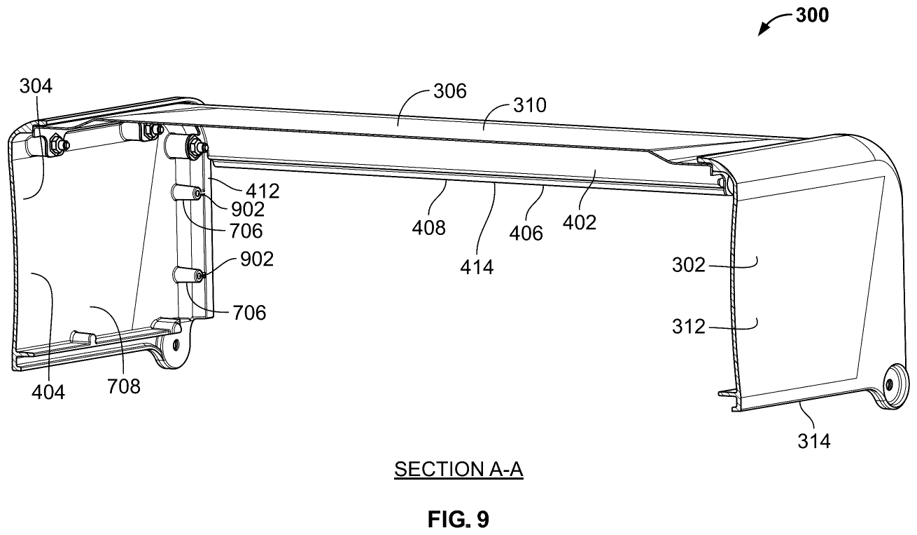

FIG. 3 is a first perspective view of an example lid 300 constructed in accordance with the teachings of this disclosure. FIG. 4 is a second perspective view of the lid 300 of FIG. 3. FIG. 5 is a rear view of the lid 300 of FIGS. 3 and 4. FIG. 6 is a top view of the lid 300 of FIGS. 3-5. FIG. 7 is a cross-sectional view of the lid 300 of FIGS. 3-6, taken along section A-A of FIG. 6. FIG. 8 is a first perspective view of the cross-sectional view of FIG. 7. FIG. 9 is a second perspective view of the cross-sectional view of FIG. 7. The lid 300 of FIGS. 3-9 includes an example right end cap 302, an example left end cap 304 located opposite to the right end cap 302, and an example central wall panel 306 extending between and coupled to the right end cap 302 and the left end cap 304. In the illustrated example of FIGS. 3-9, the right end cap 302 and the left end cap 304 of the lid 300 are removably couplable (e.g., via a plurality of fasteners) to the central wall panel 306 of the lid 300.

In some examples, the right end cap 302 and the left end cap 304 of the lid 300 of FIGS. 3-9 are placed into and/or remain in an uncoupled and/or unassembled state relative to the central wall panel 306 of the lid 300 during packaging and/or shipping of a commercial product (e.g., a grill) that includes the lid 300. The ability to maintain the right end cap 302 and the left end cap 304 of the lid 300 in an uncoupled and/or unassembled state relative to the central wall panel 306 of the lid 300 during packaging and/or shipping advantageously enables the contents and/or components of the commercial product to be loaded into a shipping container (e.g., a box) having one or more dimension(s) that is/are reduced relative to the dimension(s) that would otherwise be necessary to contain the same contents and/or components of the packaged and/or shipped commercial product in instances when the right end cap 302 and the left end cap 304 of the lid 300 are coupled to the central wall panel 306 of the lid 300. The aforementioned space reduction benefits are further enhanced by the additional capability of maintaining the rear wall panel 100 of FIGS. 1 and 2 in an uncoupled and/or unassembled state relative to other uncoupled and/or unassembled components (e.g., the right end cap 302, the left end cap 304, and/or the central wall panel 306) of the lid 300 of FIGS. 3-9 during packaging and/or shipping of the commercial product.

The lid 300 of FIGS. 3-9 has a dome-shaped profile including an example front portion 308 (e.g., a front wall), an example top portion 310 (e.g., a top wall), an example rear portion 402 (e.g., a rear wall), an example right side portion 312 (e.g., a right sidewall), and an example left side portion 404 (e.g., a left sidewall). In the illustrated example of FIGS. 3-9, the front portion 308 of the lid 300 is formed in part by the right end cap 302 of the lid 300, in part by the left end cap 304 of the lid 300, and in part by the central wall panel 306 of the lid 300. The top portion 310 of the lid 300 is similarly formed in part by the right end cap 302 of the lid 300, in part by the left end cap 304 of the lid 300, and in part by the central wall panel 306 of the lid 300. The rear portion 402 of the lid 300 is similarly formed in part by the right end cap 302 of the lid 300, in part by the left end cap 304 of the lid 300, and in part by the central wall panel 306 of the lid 300. As further shown in FIGS. 3-9, the front portion 308, the rear portion 402, the right side portion 312, and the left side portion 404 of the lid 300 respectively extend downward from the top portion 310 of the lid 300, with the front portion 308, the rear portion 402, the right side portion 312, and the left side portion 404 collectively defining an example lower rim 314 of the lid 300. The lid 300 of FIGS. 3-9 is configured to be pivotally coupled to a cookbox such that the lid 300 is movable relative to the cookbox between a closed position and an open position, as further described herein. In some examples, movement of the lid 300 between the closed position and the open position can be facilitated via an example handle 316 that is located and/or extends along the front portion 308 of the lid 300.

The lid 300 of FIGS. 3-9 further includes an example outlet 406 located along the rear portion 402 of the lid 300. The rear wall panel 100 of FIGS. 1 and 2 is removably couplable to the lid 300 of FIGS. 3-9, with the rear wall panel 100 being configured to occupy (e.g., fill, extend across, and/or cover) at least a portion of the outlet 406 when the rear wall panel 100 is coupled to the lid 300. In some examples, the rear wall panel 100 occupies a majority (e.g., fifty percent or more) of the outlet 406 when the rear wall panel 100 is coupled to the lid 300. In some examples, the rear wall panel 100 occupies a substantial entirety (e.g., ninety percent or more) of the outlet 406 when the rear wall panel 100 is coupled to the lid 300. When the rear wall panel 100 of FIGS. 1 and 2 is coupled to the lid 300 of FIGS. 3-9, the lower edge 104 of the rear wall panel 100 forms a portion of a lower rim of a lid assembly that includes both the lid 300 and the rear wall panel 100, as further described herein.

In the illustrated example of FIGS. 3-9, the outlet 406 is defined by an example edge 408 of the rear portion 402 of the lid 300. The lid 300 of FIGS. 3-9 and the rear wall panel 100 of FIGS. 1 and 2 are configured such that the upper edge 102, the right edge 106, and the left edge 202 of the rear wall panel 100 engage and/or are positioned adjacent to the edge 408 of the rear portion 402 of the lid 300 when the rear wall panel 100 is coupled to the lid 300. More specifically, as shown in FIGS. 3-9, the edge 408 of the rear portion 402 of the lid 300 includes an example right segment 410, an example left segment 412 located opposite the right segment 410, and an example upper segment 414 extending between the right segment 410 and the left segment 412. The lid 300 of FIGS. 3-9 and the rear wall panel 100 of FIGS. 1 and 2 are configured such that the upper edge 102, the right edge 106, and the left edge 202 of the rear wall panel 100 respectively engage and/or are respectively positioned adjacent to corresponding ones of the upper segment 414, the right segment 410, and the left segment 412 of the edge 408 of the rear portion 402 of the lid 300 when the rear wall panel 100 is coupled to the lid 300.

The lid 300 of FIGS. 3-9 further includes one or more example first mounting boss(es) 702 located along and extending inwardly from an example interior surface 704 of the right end cap 302 of the lid 300, and one or more example second mounting boss(es) 706 located along and extending inwardly from an example interior surface 708 of the left end cap 304 of the lid 300. In the illustrated example of FIGS. 3-9, the one or more first mounting boss(es) 702 of the right end cap 302 of the lid 300 include(s) a corresponding one or more example first threaded opening(s) 802 formed in the one or more first mounting boss(es) 702 (e.g., a first one of the first threaded opening(s) 802 formed in a first one of the first mounting boss(es) 702, a second one of the first threaded opening(s) 802 formed in a second one of the first mounting boss(es) 702, etc.), with the one or more first threaded opening(s) 802 being configured to receive a corresponding one or more first threaded fastener(s) (e.g., a first one of the first threaded opening(s) 802 receives a first one of the first threaded fastener(s), a second one of the first threaded opening(s) 802 receives a second one of the first threaded fastener(s), etc.). The one or more second mounting boss(es) 706 of the left end cap 304 of the lid 300 similarly include(s) a corresponding one or more example second threaded opening(s) 902 formed in the one or more second mounting boss(es) 706 (e.g., a first one of the second threaded opening(s) 902 formed in a first one of the second mounting boss(es) 706, a second one of the second threaded opening(s) 902 formed in a second one of the second mounting boss(es) 706, etc.), with the one or more second threaded opening(s) 902 being configured to receive a corresponding one or more second threaded fastener(s) (e.g., a first one of the second threaded opening(s) 902 receives a first one of the second threaded fastener(s), a second one of the second threaded opening(s) 902 receives a second one of the second threaded fastener(s), etc.).

The rear wall panel 100 of FIGS. 1 and 2 is configured to be coupled to the lid 300 of FIGS. 3-9 via the first threaded fastener(s) associated with corresponding ones of the first opening(s) 114 of the first mounting flange 110 of the rear wall panel 100 and corresponding ones of the first threaded opening(s) 802 of the first mounting boss(es) 702 of the right end cap 302 of the lid 300, and further via the second threaded fastener(s) associated with corresponding ones of the second opening(s) 116 of the second mounting flange 112 of the rear wall panel 100 and corresponding ones of the second threaded opening(s) 902 of the second mounting boss(es) 706 of the left end cap 304 of the lid 300. When the rear wall panel 100 of FIGS. 1 and 2 is coupled to the lid 300 of FIGS. 3-9, the first threaded fastener(s) extend(s) through the first opening(s) 114 of the first mounting flange 110 of the rear wall panel 100 and into the first threaded opening(s) 802 of the first mounting boss(es) 702 of the right end cap 302 of the lid 300, and the second threaded fastener(s) extend(s) through the second opening(s) 116 of the second mounting flange 112 of the rear wall panel 100 and into the second threaded opening(s) 902 of the second mounting boss(es) 706 of the left end cap 304 of the lid 300. The rear wall panel 100 of FIGS. 1 and 2 can be coupled and/or attached to the lid 300 of FIGS. 3-9 by tightening or otherwise securing the first threaded fasteners and the second threaded fasteners. Conversely, the rear wall panel 100 of FIGS. 1 and 2 can be uncoupled and/or detached from the lid 300 of FIGS. 3-9 by loosening or otherwise removing the first threaded fasteners and the second threaded fasteners. In some examples, the rear wall panel 100 of FIGS. 1 and 2 and the lid 300 of FIGS. 3-9 collectively form a lid assembly when the rear wall panel 100 is coupled to the lid 300, as further described herein.

In the illustrated example of FIGS. 3-9, the outlet 406 of the rear portion 402 of the lid 300 is configured to have a lateral width (e.g., measured between the right segment 410 and the left segment 412 of the edge 408 of the rear portion 402 of the lid 300) of approximately 61.0 centimeters. In other examples, the lateral width of the outlet 406 of the rear portion 402 of the lid 300 can differ significantly relative to the above-described dimension. In this regard, it is to be understood that the lid 300 will be configured such that the lateral width chosen for the outlet 406 of the rear portion 402 of the lid 300 will be dictated in part by the lateral width chosen for the rear wall panel 100 that is to be occupy the outlet 406 of the rear portion 402 of the lid 300 when the rear wall panel 100 is coupled to the lid 300, as further described herein.

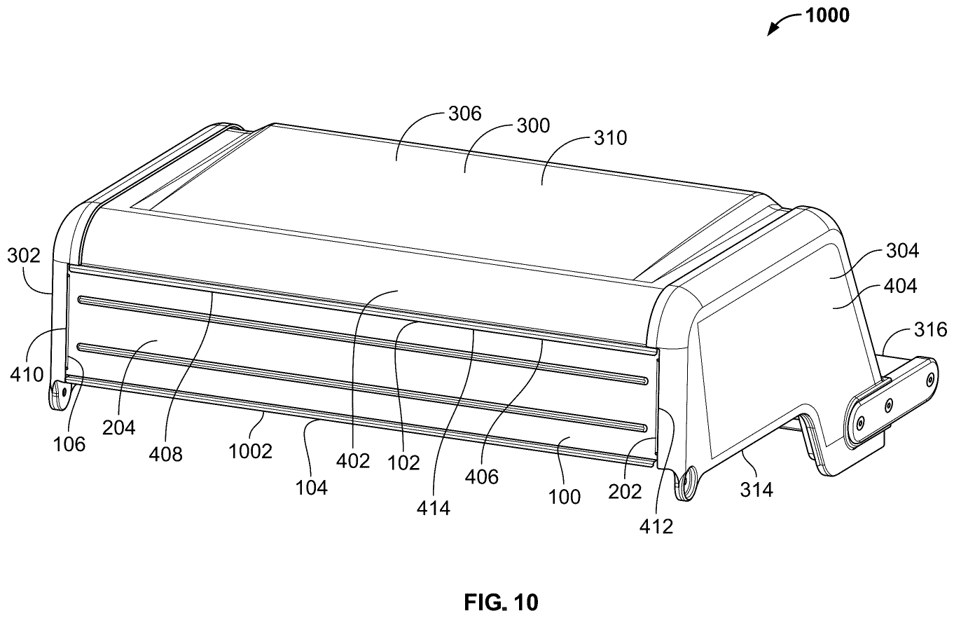

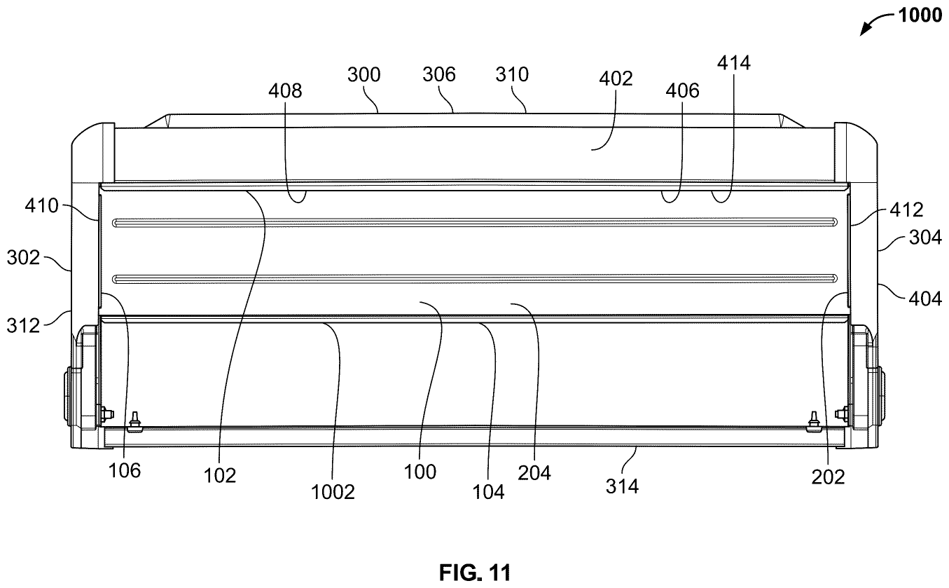

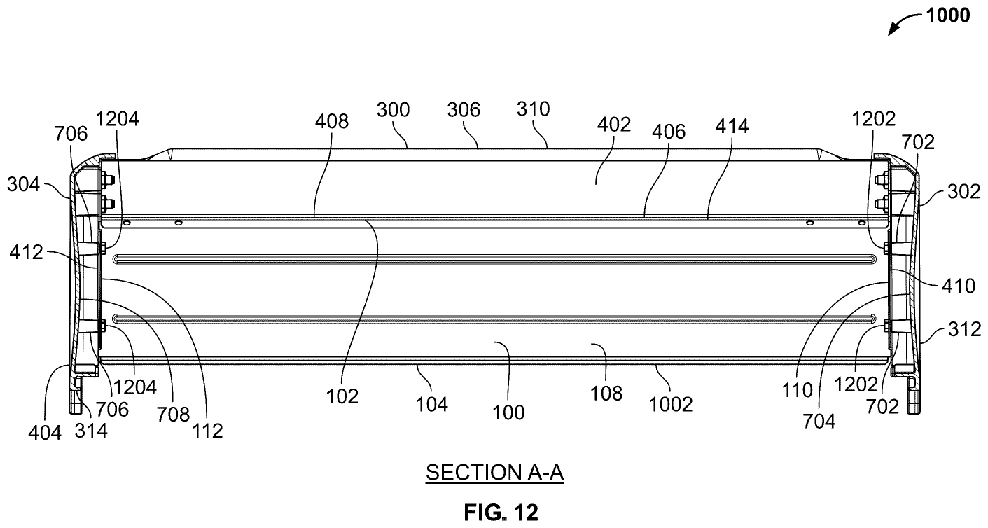

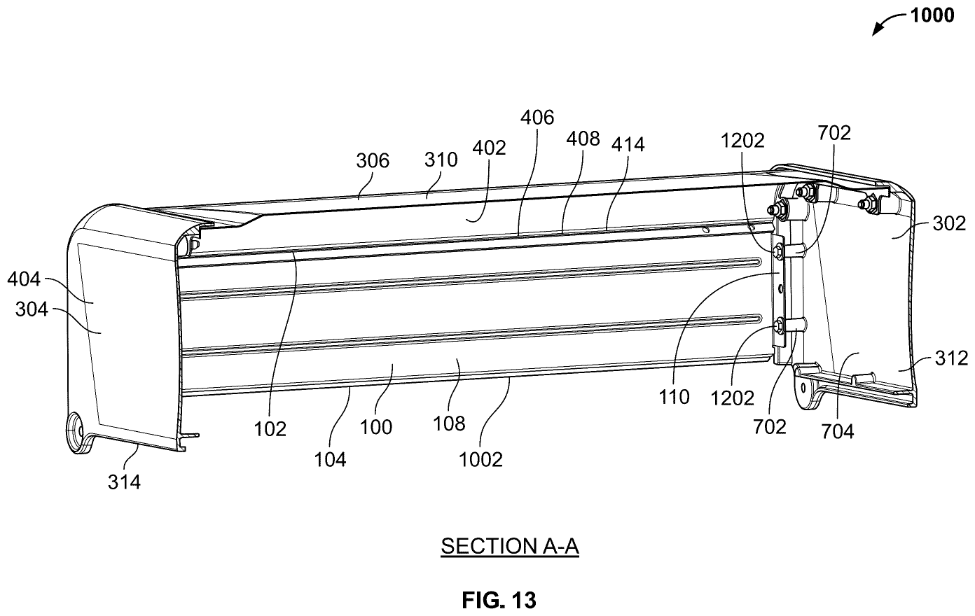

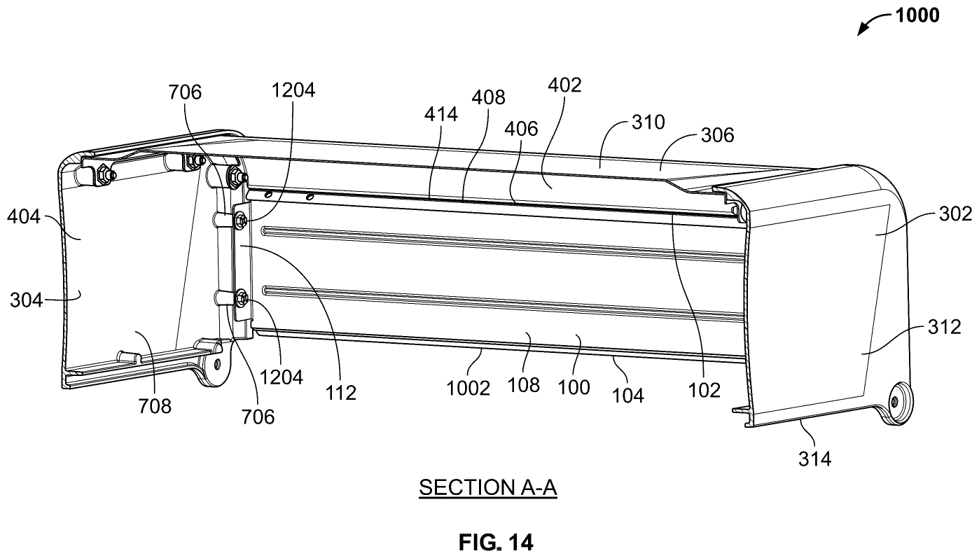

FIG. 10 is a perspective view of an example lid assembly 1000 including the rear wall panel 100 of FIGS. 1 and 2 and the lid 300 of FIGS. 3-9. FIG. 11 is a rear view of the lid assembly 1000 of FIG. 10. FIG. 12 is a cross-sectional view of the lid assembly 1000 of FIGS. 10 and 11, taken along section A-A of FIG. 6. FIG. 13 is a first perspective view of the cross-sectional view of FIG. 12. FIG. 14 is a second perspective view of the cross-sectional view of FIG. 12. The lid assembly 1000 of FIGS. 10-14 is configured to be pivotally coupled to a cookbox such that the lid assembly 1000 is movable relative to the cookbox between a closed position and an open position, as further described herein. In some examples, movement of the lid assembly 1000 between the closed position and the open position can be facilitated via the handle 316 that is located and/or extends along the front portion 308 of the lid 300 of the lid assembly 1000.

In the illustrated example of FIGS. 10-14, rear wall panel 100 of the lid assembly 1000 is removably couplable (e.g., via a plurality of threaded fasteners) to the lid 300 of the lid assembly 1000. As shown in FIGS. 10-14, the rear wall panel 100 of the lid assembly 1000 is in a coupled and/or assembled state relative to the lid 300 of the lid assembly 1000. In some examples, the rear wall panel 100 of the lid assembly 1000 is placed into and/or remains in an uncoupled and/or unassembled state relative to the lid 300 of the lid assembly 1000 during packaging and/or shipping of a commercial product (e.g., a grill) that includes the lid assembly 1000. The ability to maintain the rear wall panel 100 of the lid assembly 1000 in an uncoupled and/or unassembled state relative to the lid 300 of the lid assembly 1000 during packaging and/or shipping advantageously enables the contents and/or components of the commercial product to be loaded into a shipping container (e.g., a box) having one or more dimension(s) that is/are reduced relative to the dimension(s) that would otherwise be necessary to contain the same contents and/or components of the packaged and/or shipped commercial product in instances when the rear wall panel 100 of the lid assembly 1000 is coupled to the lid 300 of the lid assembly 1000.

As shown in FIGS. 10-14, the rear wall panel 100 of the lid assembly 1000 occupies (e.g., fills, extend across, and/or covers) at least a portion of the outlet 406 of the lid 300 of the lid assembly 1000 when the rear wall panel 100 is coupled to the lid 300. More specifically, as further shown in FIGS. 10-14, the rear wall panel 100 of the lid assembly 1000 occupies a majority (e.g., fifty percent or more) of the outlet 406 of the lid 300 of the lid assembly 1000 when the rear wall panel 100 is coupled to the lid 300. Still more specifically, as further shown in FIGS. 10-14, the rear wall panel 100 of the lid assembly 1000 occupies a substantial entirety (e.g., ninety percent or more) of the outlet 406 of the lid 300 of the lid assembly 1000 when the rear wall panel 100 is coupled to the lid 300. When the rear wall panel 100 of the lid assembly 1000 is coupled to the lid 300 of the lid assembly 1000 (e.g., as shown in FIGS. 10-14), the lower edge 104 of the rear wall panel 100 forms a portion of an example lower rim 1002 of the lid assembly 1000. The lower rim 1002 of the lid assembly 1000 further includes one or more portion(s) of the lower rim 314 of the lid 300 as it existed prior to the rear wall panel 100 being coupled to the lid 300, and as it still exists subsequent to the rear wall panel 100 being coupled to the lid 300.

In the illustrated example of FIGS. 10-14, the rear wall panel 100 and the lid 300 of the lid assembly 1000 are configured such that the upper edge 102, the right edge 106, and the left edge 202 of the rear wall panel 100 engage and/or are positioned adjacent to the edge 408 of the rear portion 402 of the lid 300 when the rear wall panel 100 is coupled to the lid 300, as shown in FIGS. 10-14. More specifically, the rear wall panel 100 and the lid 300 of the lid assembly 1000 are configured such that the upper edge 102, the right edge 106, and the left edge 202 of the rear wall panel 100 respectively engage and/or are respectively positioned adjacent to corresponding ones of the upper segment 414, the right segment 410, and the left segment 412 of the edge 408 of the rear portion 402 of the lid 300 when the rear wall panel 100 is coupled to the lid 300, as shown in FIGS. 10-14.

The lid 300 of FIGS. 3-9 further includes one or more example first mounting boss(es) 702 located along and extending inwardly from an example interior surface 704 of the right end cap 302 of the lid 300, and one or more example second mounting boss(es) 706 located along and extending inwardly from an example interior surface 708 of the left end cap 304 of the lid 300. In the illustrated example of FIGS. 3-9, the one or more first mounting boss(es) 702 of the right end cap 302 of the lid 300 include(s) a corresponding one or more example first threaded opening(s) 802 formed in the one or more first mounting boss(es) 702 (e.g., a first one of the first threaded opening(s) 802 formed in a first one of the first mounting boss(es) 702, a second one of the first threaded opening(s) 802 formed in a second one of the first mounting boss(es) 702, etc.), with the one or more first threaded opening(s) 802 being configured to receive a corresponding one or more first threaded fastener(s) (e.g., a first one of the first threaded opening(s) 802 receives a first one of the first threaded fastener(s), a second one of the first threaded opening(s) 802 receives a second one of the first threaded fastener(s), etc.). The one or more second mounting boss(es) 706 of the left end cap 304 of the lid 300 similarly include(s) a corresponding one or more example second threaded opening(s) 902 formed in the one or more second mounting boss(es) 706 (e.g., a first one of the second threaded opening(s) 902 formed in a first one of the second mounting boss(es) 706, a second one of the second threaded opening(s) 902 formed in a second one of the second mounting boss(es) 706, etc.), with the one or more second threaded opening(s) 902 being configured to receive a corresponding one or more second threaded fastener(s) (e.g., a first one of the second threaded opening(s) 902 receives a first one of the second threaded fastener(s), a second one of the second threaded opening(s) 902 receives a second one of the second threaded fastener(s), etc.).

In the illustrated example of FIGS. 10-14, the rear wall panel 100 of the lid assembly 1000 is coupled to the lid 300 of the lid assembly 1000 via one or more example first threaded fastener(s) 1202 associated with corresponding ones of the first opening(s) 114 of the first mounting flange 110 of the rear wall panel 100 and corresponding ones of the first threaded opening(s) 802 of the first mounting boss(es) 702 of the right end cap 302 of the lid 300, and further via one or more example second threaded fastener(s) 1204 associated with corresponding ones of the second opening(s) 116 of the second mounting flange 112 of the rear wall panel 100 and corresponding ones of the second threaded opening(s) 902 of the second mounting boss(es) 706 of the left end cap 304 of the lid 300. When the rear wall panel 100 of the lid assembly 1000 is coupled to the lid 300 of the lid assembly 1000 (e.g., as shown in FIGS. 10-14), the first threaded fastener(s) 1202 extend(s) through the first opening(s) 114 of the first mounting flange 110 of the rear wall panel 100 and into the first threaded opening(s) 802 of the first mounting boss(es) 702 of the right end cap 302 of the lid 300, and the second threaded fastener(s) 1204 extend(s) through the second opening(s) 116 of the second mounting flange 112 of the rear wall panel 100 and into the second threaded opening(s) 902 of the second mounting boss(es) 706 of the left end cap 304 of the lid 300. The rear wall panel 100 of the lid assembly 1000 can be coupled and/or attached to the lid 300 of the lid assembly 1000 by tightening or otherwise securing the first threaded fasteners 1202 and the second threaded fasteners 1204. Conversely, the rear wall panel 100 of the lid assembly 1000 can be uncoupled and/or detached from the lid 300 of the lid assembly 1000 by loosening or otherwise removing the first threaded fasteners 1202 and the second threaded fasteners 1204.

In the illustrated example of FIGS. 10-14, the rear wall panel 100 of the lid assembly 1000 has a height (e.g., measured between the upper edge 102 and the lower edge 104 of the rear wall panel 100) of approximately 11.0 centimeters, and a lateral width (e.g., measured between the right edge 106 and the left edge 202 of the rear wall panel 100) of approximately 61.0 centimeters. The outlet 406 of the rear portion 402 of the lid 300 of the lid assembly 1000 has a lateral width (e.g., measured between the right segment 410 and the left segment 412 of the edge 408 of the rear portion 402 of the lid 300) of approximately 61.0 centimeters. Thus, as shown in FIGS. 10-14, the lateral width of the of the rear wall panel 100 and the lateral width of the outlet 406 of the rear portion 402 of the lid 300 are substantially the same. In other examples, the height and/or the lateral width of the rear wall panel 100, and/or a height and/or the lateral width of the outlet 406 of the rear portion 402 of the lid 300, can differ significantly relative to the above-described dimensions. In this regard, it is to be understood that the rear wall panel 100 and the lid 300 will be configured such that the height and/or the lateral width chosen for the rear wall panel 100 will be dictated in part by the height and/or the lateral width chosen for the outlet 406 of the rear portion 402 of the lid 300 that is to be occupied by the rear wall panel 100 when the rear wall panel 100 is coupled to the lid 300, as shown in FIGS. 10-14.

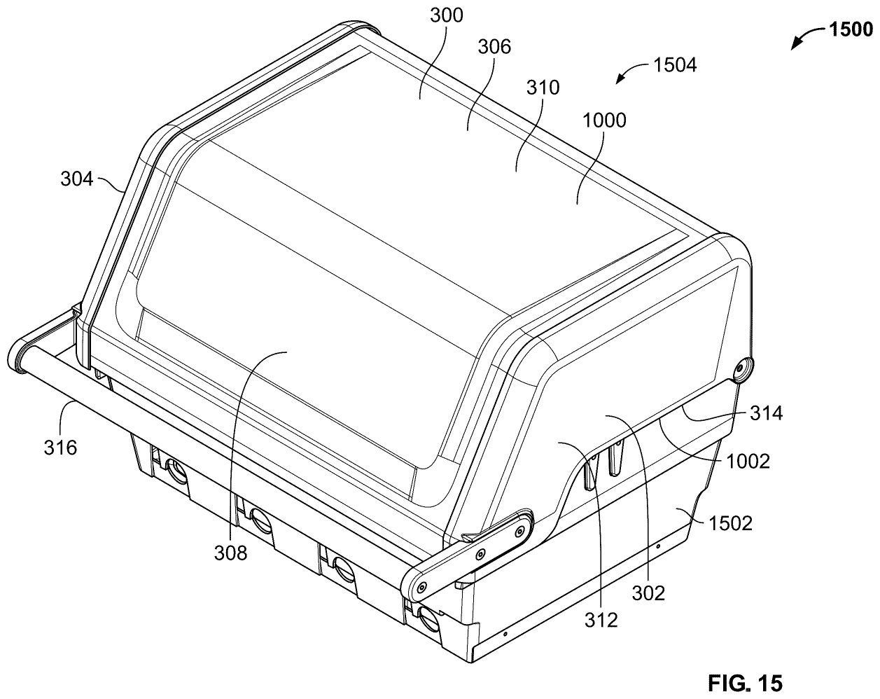

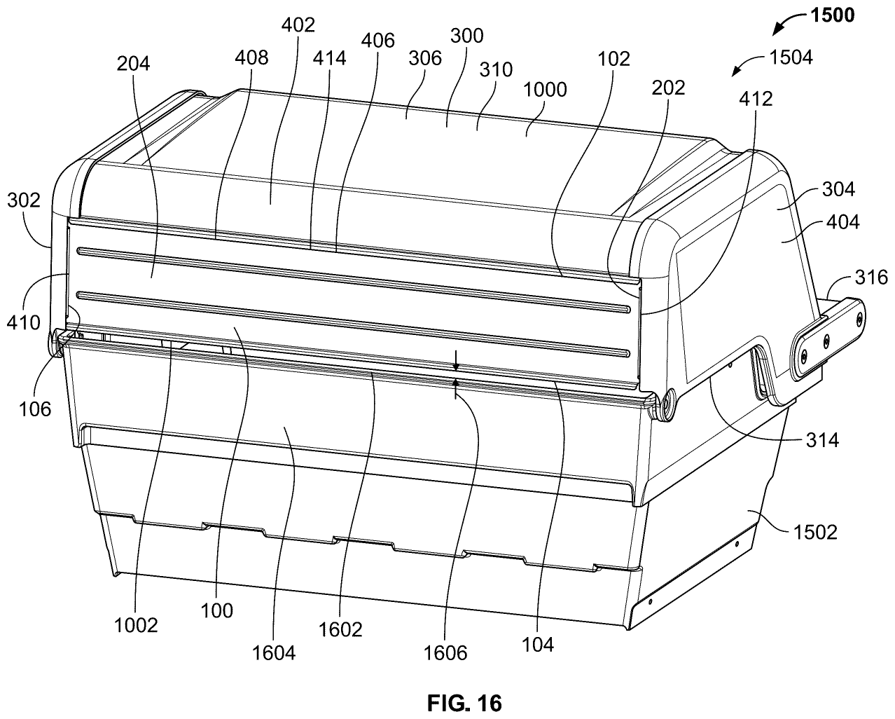

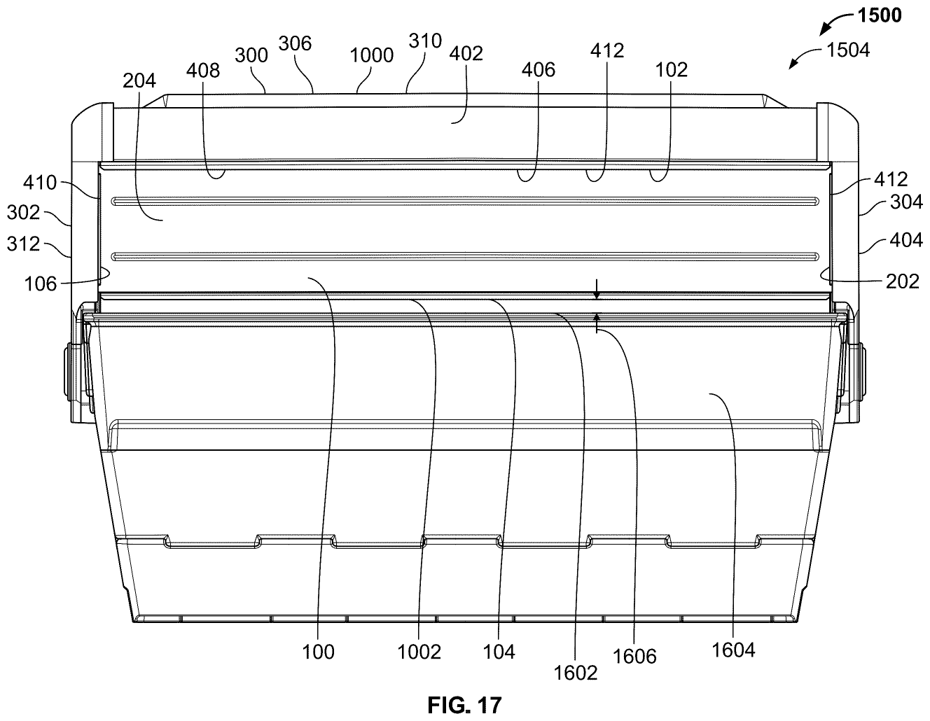

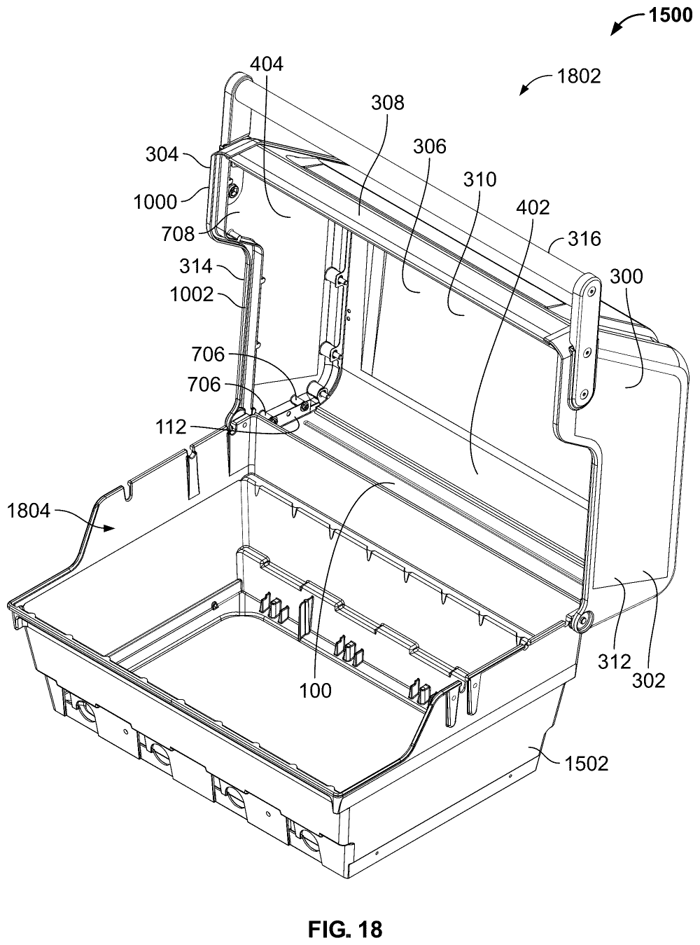

FIG. 15 is a first perspective view of an example cooking chamber assembly 1500 including an example cookbox 1502 and the lid assembly 1000 of FIGS. 10-14, with the lid 300 of the lid assembly 1000 shown in an example closed position 1504 relative to the cookbox 1502. FIG. 16 is a second perspective view of the cooking chamber assembly 1500 of FIG. 15. FIG. 17 is a rear view of the cooking chamber assembly 1500 of FIGS. 15 and 16. FIG. 18 is a perspective view of the cooking chamber assembly 1500 of FIGS. 15-17, with the lid 300 of the lid assembly 1000 shown in an example open position 1802 relative to the cookbox 1502. The cooking chamber assembly 1500 of FIGS. 15-18 is configured such that the lid assembly 1000 of the cooking chamber assembly 1500 is pivotally coupled to the cookbox 1502 of the cooking chamber assembly 1500, such that the lid assembly 1000 is movable relative to the cookbox 1502 between the closed position 1504 (e.g., as shown in FIGS. 15-17) and the open position 1802 (e.g., as shown in FIG. 18). In some examples, movement of the lid assembly 1000 between the closed position 1504 and the open position 1802 can be facilitated via the handle 316 that is located and/or extends along the front portion 308 of the lid 300 of the lid assembly 1000.

In the illustrated example of FIGS. 15-18, the lid assembly 1000 of the cooking chamber assembly 1500 is removably couplable (e.g., via a plurality of pins and/or fasteners) to the cookbox 1502 of the cooking chamber assembly 1500. As shown in FIGS. 15-18, the lid assembly 1000 of the cooking chamber assembly 1500 is in a coupled and/or assembled state relative to the cookbox 1502 of the cooking chamber assembly 1500. In some examples, the lid assembly 1000 of the cooking chamber assembly 1500 is placed into and/or remains in an uncoupled and/or unassembled state relative to the cookbox 1502 of the cooking chamber assembly 1500 during packaging and/or shipping of a commercial product (e.g., a grill) that includes the cooking chamber assembly 1500. The ability to maintain the lid assembly 1000 of the cooking chamber assembly 1500 in an uncoupled and/or unassembled state relative to the cookbox 1502 of the cooking chamber assembly 1500 during packaging and/or shipping advantageously enables the contents and/or components of the commercial product to be loaded into a shipping container (e.g., a box) having one or more dimension(s) that is/are reduced relative to the dimension(s) that would otherwise be necessary to contain the same contents and/or components of the packaged and/or shipped commercial product in instances when the lid assembly 1000 of the cooking chamber assembly 1500 is coupled to the cookbox 1502 of the cooking chamber assembly 1500.

The cooking chamber assembly 1500 of FIGS. 15-18 includes an example cooking chamber 1804 defined at least in part by the lid assembly 1000 and the cookbox 1502 of the cooking chamber assembly 1500. As shown in FIGS. 16 and 17, the lid assembly 1000 and the cookbox 1502 of the cooking chamber assembly 1500 are configured such that the lower edge 104 of the rear wall panel 100 of the lid assembly 1000 is spaced apart from an example upper edge 1602 of an example rear wall 1604 of the cookbox 1502 by an example gap 1606 when the lid assembly 1000 is in the closed position 1504 relative to the cookbox 1502. The gap 1606 formed between the lower edge 104 of the rear wall panel 100 of the lid assembly 1000 and the upper edge 1602 of the rear wall 1604 of the cookbox 1502 is configured to vent heated air from within the cooking chamber 1804 to a location that is external relative to the cooking chamber 1804. In some examples, the gap 1606 has a minimum height of 1.0 millimeter. In some examples, the gap 1606 has a maximum height of 50.0 millimeters. As shown in FIGS. 16 and 17, the gap 1606 has a uniform height of approximately 25.0 millimeters along the entirety of the lower edge 104 of the rear wall panel 100 of the lid assembly 1000.

In the illustrated example of FIGS. 15-18, the cookbox 1502 of the cooking chamber assembly 1500 is a cookbox for a gas grill, with the cookbox 1502 being configured to carry and/or support one or more gas burner(s) that is/are located at least partially within the cooking chamber 1804, and with such gas burner(s) being configured to generate heat (e.g., via the combustion of gas located within the gas burner(s)) to cook one or more item(s) of food located within the cooking chamber 1804. In other examples, the cookbox 1502 of the cooking chamber assembly 1500 can instead be for a different type of grill, with the cookbox 1502 being configured to carry and/or support a different type of heat-generating source. For example, the cookbox 1502 of the cooking chamber assembly 1500 can instead be for a pellet grill, with the cookbox 1502 being configured to carry and/or support a burn pot that is located at least partially within the cooking chamber 1804, and with such burn pot being configured to generate heat (e.g., via the combustion of wood pellets located within the burn pot) to cook one or more item(s) of food located within the cooking chamber 1804. As another example, the cookbox 1502 of the cooking chamber assembly 1500 can instead be for an electric grill, with the cookbox 1502 being configured to carry and/or support one or more electric heating element(s) that is/are located at least partially within the cooking chamber 1804, and with such electric heating element(s) being configured to generate heat (e.g., emitted from the heating element(s) in response to an electrical current supplied to the heating element(s)) to cook one or more item(s) of food located within the cooking chamber 1804. As yet another example, the cookbox 1502 of the cooking chamber assembly 1500 can instead be for a charcoal grill, with the cookbox 1502 being configured to carry and/or support a fuel grate that is located at least partially within the cooking chamber 1804, with the fuel grate being configured to support charcoal (e.g., charcoal briquettes), and with such charcoal being configured to generate heat (e.g., via combustion of the charcoal) to cook one or more item(s) of food located within the cooking chamber 1804.

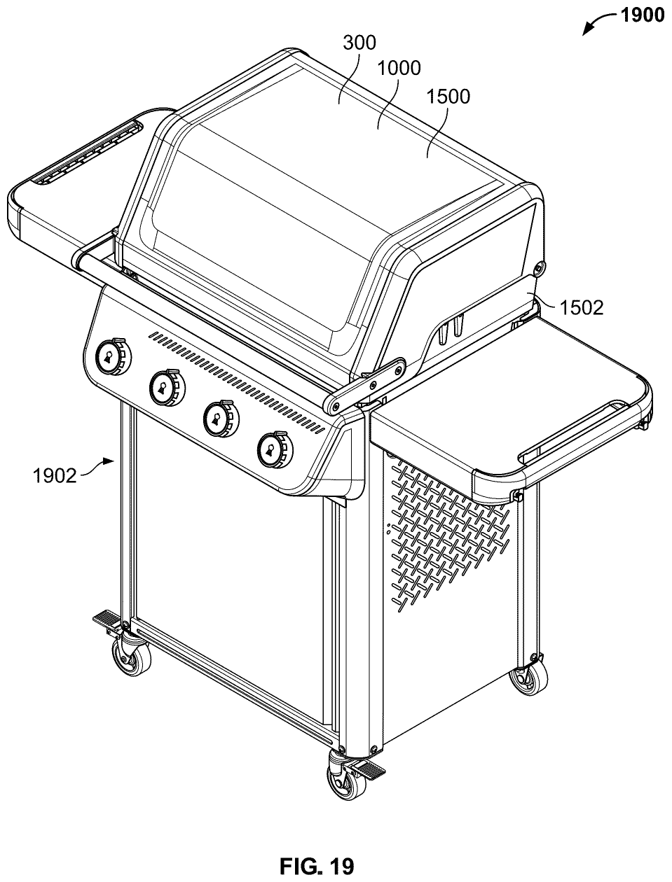

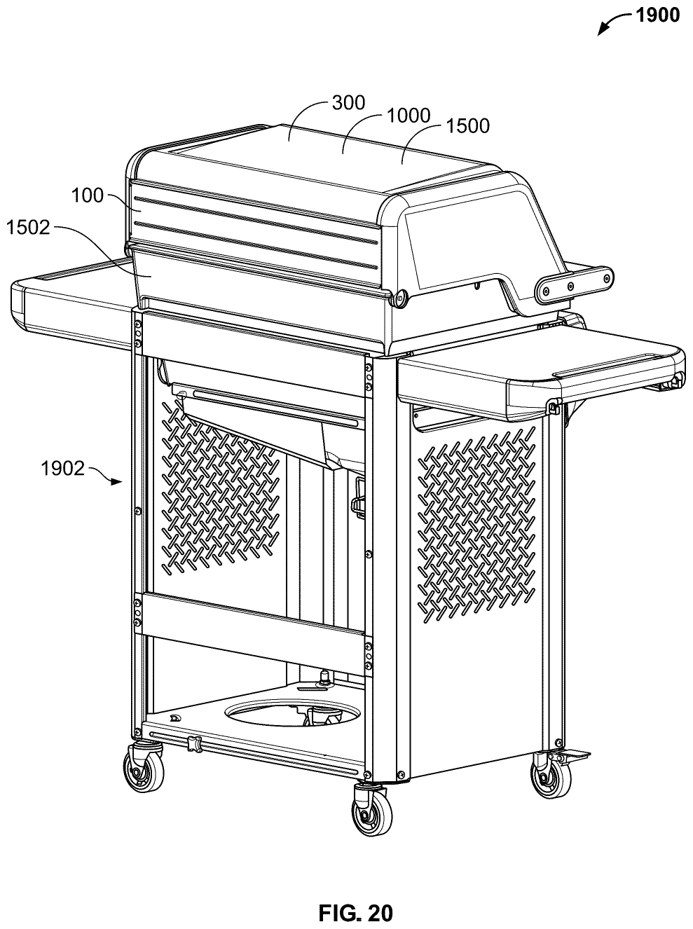

FIG. 19 is a first perspective view of an example grill 1900 including the cooking chamber assembly 1500 of FIGS. 15-18. FIG. 20 is a second perspective view of the grill 1900 of FIG. 19. The grill 1900 of FIGS. 19 and 20 includes an example frame 1902 configured to support the cooking chamber assembly 1500 such that the cooking chamber assembly 1500 is located above and/or spaced apart from an underlying ground surface. In the illustrated example of FIGS. 19 and 20, the lid assembly 1000 of the cooking chamber assembly 1500 is pivotally coupled to the cookbox 1502 of the cooking chamber assembly 1500, and the rear wall panel 100 of the lid assembly 1000 is coupled to the lid 300 of the lid assembly 1000. The lid assembly 1000 of the grill 1900 is movable relative to the cookbox 1502 of the grill 1900 between the closed position 1504 (e.g., as shown in FIGS. 15-17) and the open position 1802 (e.g., as shown in FIG. 18). In the illustrated example of FIGS. 19 and 20, the grill 1900 is a gas grill including one or more gas burner(s) that is/are located at least partially within the cooking chamber 1804 of the cooking chamber assembly 1500 of the grill 1900, with such gas burner(s) being configured to generate heat (e.g., via the combustion of gas located within the gas burner(s)) to cook one or more item(s) of food located within the cooking chamber 1804. As discussed above, in other examples the grill 1900 can be configured as a different type of grill (e.g., a pellet grill, an electric grill, a charcoal grill, etc.) and the cookbox 1502 of the cooking chamber assembly 1500 of the grill 1900 can accordingly be alternatively configured to carry and/or support a corresponding different type of heat-generating source (e.g., a burn pot configured to receive combustible wood pellets, an electric heating element configured to receive an electrical current, a fuel grate configured to support combustible charcoal, etc.).

In the illustrated examples of FIGS. 1-20 described above, the rear wall panel 100 of FIGS. 1 and 2 that is incorporated into the lid assembly 1000 of FIGS. 10-14, which in turn is incorporated into the cooking chamber assembly 1500 of FIGS. 15-18, which in turn is incorporated into the grill 1900 of FIGS. 19 and 20, is one of several modular rear wall panels that can interchangeably be removably coupled to the lid 300 of FIGS. 3-9 described above. The interchangeability of such modular rear wall panels advantageously facilitates a modular and/or customizable lid assembly system in which different ones of the modular rear wall panels having different lower edge shape features (e.g., a first rear wall panel having a linear lower edge, a second rear wall panel having a non-linear lower edge, etc.), different vent opening features (e.g., a first rear wall panel lacking any vent openings extending therethrough, a second rear wall panel having one or more vent opening(s) extending therethrough, etc.), and/or different height features (e.g., a first rear wall panel having a first height, a second rear wall panel having a second height differing from the first height, etc.) can selectively and/or interchangeably be coupled to the lid 300 of FIGS. 3-9 to provide unique, customized, and/or different versions of the lid assembly 1000 of FIGS. 10-14 described above. Each such different version of the lid assembly 1000 will in turn advantageously include and/or advantageously provide a unique, customized, and/or different venting profile, venting pattern, venting capacity, and/or venting capability associated therewith when such different version of the lid assembly 1000 is coupled to the cookbox 1502 to form the cooking chamber assembly 1500.

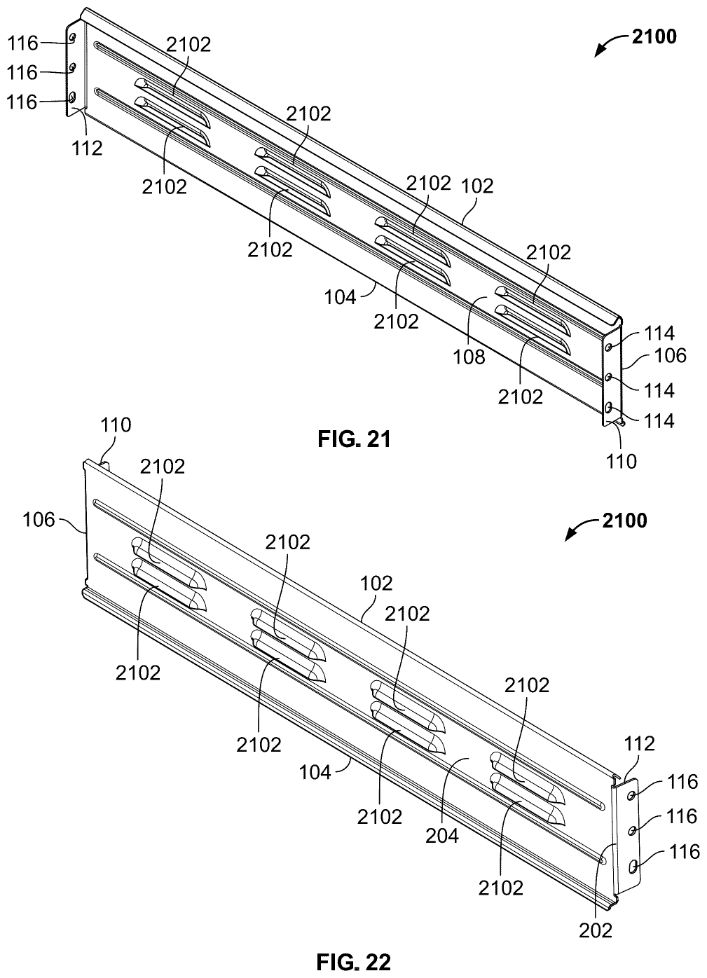

As discussed above, the rear wall panel 100 of FIGS. 1 and 2 represents one rear wall panel that forms part of a modular rear wall panel system in relation to the lid 300 of FIGS. 3-9, the lid assembly 1000 of FIGS. 10-14, the cooking chamber assembly 1500 of FIGS. 15-18, and/or the grill 1900 of FIGS. 19 and 20. FIG. 21 is a first perspective view of another example rear wall panel 2100 constructed in accordance with the teachings of this disclosure, and configured for use with and/or installation on a lid of a grill. FIG. 22 is a second perspective view of the rear wall panel 2100 of FIG. 21. The rear wall panel 2100 of FIGS. 21 and 22 generally includes the same structural features and/or characteristics as the rear wall panel 100 of FIGS. 1 and 2 described above. The rear wall panel 2100 of FIGS. 21 and 22 differs from the rear wall panel 100 of FIGS. 1 and 2 only with respect to the presence and/or absence of one or more vent opening(s). In this regard, the front surface 108 and the rear surface 204 of the rear wall panel 100 of FIGS. 1 and 2 are free of (e.g., do not include) any openings formed in and extending therethrough. The rear wall panel 100 of FIGS. 1 and 2 accordingly does not include any vents, any through holes, and/or any other openings formed in and extending through the front surface 108 and/or the rear surface 204 of the rear wall panel 100. By contrast, the rear wall panel 2100 of FIGS. 21 and 22 includes one or more example vent opening(s) 2102 formed in and extending through the front surface 108 and the rear surface 204 of the rear wall panel 2100. The presence of such vent opening(s) 2102 in the rear wall panel 2100 results in the rear wall panel 2100 of FIGS. 21 and 22 being different from, and/or unique relative to, the rear wall panel 100 of FIGS. 1 and 2.

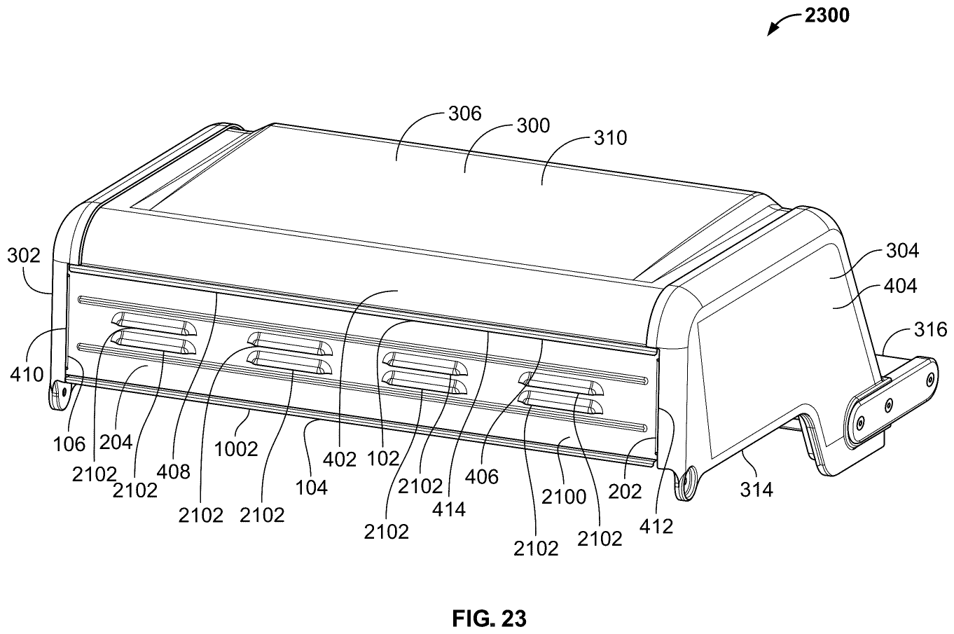

The rear wall panel 2100 of FIGS. 21 and 22 is removably couplable to the lid 300 of FIGS. 3-9 in the same way that the rear wall panel 100 of FIGS. 1 and 2 is removably couplable to the lid 300 of FIGS. 3-9, as described above. The rear wall panel 100 of FIGS. 1 and 2 and the rear wall panel 2100 of FIGS. 21 and 22 can accordingly be interchangeably coupled to the lid 300 of FIGS. 3-9 to produce unique, customized, and/or different versions of the lid assembly 1000 of FIGS. 10-14 described above, which in turn produces unique, customized, and/or different versions of the cooking chamber assembly 1500 of FIGS. 15-18 described above, and/or unique, customized, and/or different versions of the grill 1900 of FIGS. 19 and 20 described above. For example, FIG. 23 is a perspective view of an example lid assembly 2300 including the rear wall panel 2100 of FIGS. 21 and 22 and the lid 300 of FIGS. 3-9. The lid assembly 2300 of FIG. 23 is unique, customized, and/or different relative to the lid assembly 1000 of FIGS. 10-15 by virtue of the above-described difference(s) between the rear wall panel 2100 of FIGS. 21 and 22 relative to the rear wall panel 100 of FIGS. 1 and 2. The lid assembly 2300 of FIG. 23 accordingly produces a unique, customized, and/or different version of the cooking chamber assembly 1500 of FIGS. 15-18 described above, and/or a unique, customized, and/or different version of the grill 1900 of FIGS. 19 and 20 described above relative to the version of the cooking chamber assembly 1500 of FIGS. 15-18 and/or the version of the grill 1900 of FIGS. 19 and 20 that results from implementation of the lid assembly 1000 of FIGS. 10-14.

The following paragraphs provide various examples in relation to the disclosed grill lids including modular rear wall panels.

Example 1 includes a grill. In Example 1, the grill includes a cookbox, a lid, and a rear wall panel. The lid includes an outlet located along a rear portion of the lid. The rear wall panel is removably couplable to the lid. The rear wall panel is configured to occupy at least a portion of the outlet when the rear wall panel is coupled to the lid.

Example 2 includes the grill of Example 1. In Example 2, the rear wall panel includes an upper edge, a lower edge, a right edge, a left edge, a front surface, and a rear surface. The lower edge is located opposite the upper edge. The right edge extends between the upper edge and the lower edge. The left edge is located opposite the right edge and extends between the upper edge and the lower edge. The front surface extends between the upper edge, the lower edge, the right edge, and the left edge. The rear surface is located opposite the front surface and extends between the upper edge, the lower edge, the right edge, and the left edge.

Example 3 includes the grill of Example 2. In Example 3, the lower edge defines a portion of a lower rim of a lid assembly when the rear wall panel is coupled to the lid, wherein the lid assembly includes the rear wall panel and the lid.

Example 4 includes the grill of Example 2. In Example 4, the outlet is defined by an edge of the rear portion of the lid.

Example 5 includes the grill of Example 4. In Example 5, the lid and the rear wall panel are configured such that the upper edge, the right edge, and the left edge of the rear wall panel are positioned adjacent to the edge of the rear portion of the lid when the rear wall panel is coupled to the lid.

Example 6 includes the grill of Example 4. In Example 6, the edge of the rear portion of the lid includes a right segment, a left segment located opposite the right segment, and an upper segment extending between the right segment and the left segment. In Example 6, the lid and the rear wall panel are configured such that the upper edge, the right edge, and the left edge of the rear wall panel are respectively positioned adjacent to corresponding ones of the upper segment, the right segment, and the left segment of the edge of the rear portion of the lid when the rear wall panel is coupled to the lid.

Example 7 includes the grill of Example 2. In Example 7, the front surface is configured to face toward a front portion of the lid when the rear wall panel is coupled to the lid.

Example 8 includes the grill of Example 2. In Example 8, the rear wall panel further includes a first mounting flange located along the right edge and a second mounting flange located along the left edge.

Example 9 includes the grill of Example 8. In Example 9, the second mounting flange is oriented parallel relative to the first mounting flange.

Example 10 includes the grill of Example 8. In Example 10, the first mounting flange and the second mounting flange are oriented perpendicularly relative to the front surface.

Example 11 includes the grill of Example 8. In Example 11, the first mounting flange includes a first opening configured to receive a first fastener, and the second mounting flange includes a second opening configured to receive a second fastener. In Example 11, the rear wall panel is configured to be coupled to the lid via the first fastener and the second fastener. In Example 11, the first fastener extends through the first opening of the first mounting flange and the second fastener extends through the second opening of the second mounting flange when the rear wall panel is coupled to the lid.

Example 12 includes the grill of Example 2. In Example 12, the lower edge is linear.

Example 13 includes the grill of Example 2. In Example 13, the front surface and the rear surface are free of any openings extending therethrough.

Example 14 includes the grill of Example 2. In Example 14, the rear wall panel includes one or more openings extending through the front surface and the rear surface of the rear wall panel.

Example 15 includes the grill of Example 1. In Example 15, the rear wall panel is configured to occupy a majority of the outlet when the rear wall panel is coupled to the lid.

Example 16 includes the grill of Example 1. In Example 16, the rear wall panel is configured to occupy a substantial entirety of the outlet when the rear wall panel is coupled to the lid.

Example 17 includes the grill of Example 1. In Example 17, the lid is pivotally coupled to the cookbox. In Example 17, the lid is movable relative to the cookbox between a closed position and an open position.

Example 18 includes the grill of Example 17. In Example 18, the cookbox, the lid, and the rear wall panel are configured such that a lower edge of the rear wall panel is spaced apart from an upper edge of a rear wall of the cookbox by a gap when the rear wall panel is coupled to the lid and the lid is in the closed position. In Example 18, the gap is configured to vent heated air from within a cooking chamber of the grill to a location that is external relative to the cooking chamber, wherein the cooking chamber is defined at least in part by the cookbox, the lid, and the rear wall panel.

Example 19 includes the grill of Example 18. In Example 19, the gap has a minimum height of 1.0 millimeter.

Example 20 includes the grill of Example 18. In Example 20, the gap has a maximum height of 50.0 millimeters.

Although certain example apparatus, systems, methods, and articles of manufacture have been disclosed herein, the scope of coverage of this patent is not limited thereto. On the contrary, this patent covers all apparatus, systems, methods, and articles of manufacture fairly falling within the scope of the claims of this patent.

The following claims are hereby incorporated into this Detailed Description by this reference, with each claim standing on its own as a separate embodiment of the present disclosure.

What is claimed is:

1. A grill, comprising:
a cookbox;
a lid including an outlet located along a rear portion of the lid; and
a rear wall panel removably couplable to the lid, the rear wall panel configured to occupy at least a portion of the outlet when the rear wall panel is coupled to the lid.

2. The grill of claim 1, wherein the rear wall panel includes an upper edge, a lower edge, a right edge, a left edge, a front surface, and a rear surface, the lower edge located opposite the upper edge, the right edge extending between the upper edge and the lower edge, the left edge located opposite the right edge and extending between the upper edge and the lower edge, the front surface extending between the upper edge, the lower edge, the right edge, and the left edge, the rear surface located opposite the front surface and extending between the upper edge, the lower edge, the right edge, and the left edge.

3. The grill of claim 2, wherein the lower edge defines a portion of a lower rim of a lid assembly when the rear wall panel is coupled to the lid, wherein the lid assembly includes the rear wall panel and the lid.

4. The grill of claim 2, wherein the outlet is defined by an edge of the rear portion of the lid.

5. The grill of claim 4, wherein the lid and the rear wall panel are configured such that the upper edge, the right edge, and the left edge of the rear wall panel are positioned adjacent to the edge of the rear portion of the lid when the rear wall panel is coupled to the lid.

6. The grill of claim 4, wherein the edge of the rear portion of the lid includes a right segment, a left segment located opposite the right segment, and an upper segment extending between the right segment and the left segment, wherein the lid and the rear wall panel are configured such that the upper edge, the right edge, and the left edge of the rear wall panel are respectively positioned adjacent to corresponding ones of the upper segment, the right segment, and the left segment of the edge of the rear portion of the lid when the rear wall panel is coupled to the lid.

7. The grill of claim 2, wherein the front surface is configured to face toward a front portion of the lid when the rear wall panel is coupled to the lid.

8. The grill of claim 2, wherein the rear wall panel further includes a first mounting flange located along the right edge and a second mounting flange located along the left edge.

9. The grill of claim 8, wherein the second mounting flange is oriented parallel relative to the first mounting flange.

10. The grill of claim 8, wherein the first mounting flange and the second mounting flange are oriented perpendicularly relative to the front surface.

11. The grill of claim 8, wherein the first mounting flange includes a first opening configured to receive a first fastener, and the second mounting flange includes a second opening configured to receive a second fastener, wherein the rear wall panel is configured to be coupled to the lid via the first fastener and the second fastener, wherein the first fastener extends through the first opening of the first mounting flange and the second fastener extends through the second opening of the second mounting flange when the rear wall panel is coupled to the lid.

12. The grill of claim 2, wherein the lower edge is linear.

13. The grill of claim 2, wherein the front surface and the rear surface are free of any openings extending therethrough.

14. The grill of claim 2, wherein the rear wall panel includes one or more openings extending through the front surface and the rear surface of the rear wall panel.

15. The grill of claim 1, wherein the rear wall panel is configured to occupy a majority of the outlet when the rear wall panel is coupled to the lid.

16. The grill of claim 1, wherein the rear wall panel is configured to occupy a substantial entirety of the outlet when the rear wall panel is coupled to the lid.

17. The grill of claim 1, wherein the lid is pivotally coupled to the cookbox, wherein the lid is movable relative to the cookbox between a closed position and an open position.

18. The grill of claim 17, wherein the cookbox, the lid, and the rear wall panel are configured such that a lower edge of the rear wall panel is spaced apart from an upper edge of a rear wall of the cookbox by a gap when the rear wall panel is coupled to the lid and the lid is in the closed position, wherein the gap is configured to vent heated air from within a cooking chamber of the grill to a location that is external relative to the cooking chamber, wherein the cooking chamber is defined at least in part by the cookbox, the lid, and the rear wall panel.

19. The grill of claim 18, wherein the gap has a minimum height of 1.0 millimeter.

20. The grill of claim 18, wherein the gap has a maximum height of 50.0 millimeters.
